(19) United States
(12) Patent Application Publication
(10) Pub. No.: US 2011/0041932 A1
(43) Pub. Date: Feb. 24, 2011

(54) GAS SUPPLY DEVICE AND VACUUM PROCESSING APPARATUS

(75) Inventors: Nobuhiko UENO, Tama-shi (JP); Nobuhito MIYAUCHI, Hachioji-shi (JP); Hideki WAKABAYASHI, Fuchu-shi (JP)

Correspondence Address: FITZPATRICK CELLA HARPER & SCINTO, 1290 Avenue of the Americas, NEW YORK, NY, 10104-3800, US

(73) Assignee: CANON ANELVA CORPORATION, Kawasaki-shi (JP)

(21) Appl. No.: 12/857,692

(22) Filed: Aug. 17, 2010

(30) Foreign Application Priority Data
Aug. 18, 2009 (JP) 2009-188820
Aug. 4, 2010 (JP) 2010-175719

(51) Int. Cl. F15D 1/00

(52) U.S. Cl. 137/561 R

(57) ABSTRACT

A gas supply device includes a chamber frame, a door which is attached to the chamber frame to be able to open and close the door, and has a cathode, a door-side introduction block which is attached to the door and has a gas flow path for supplying discharge gas to the cathode, and a chamber-side introduction block which is attached to the chamber frame and has a gas flow path for supplying discharge gas introduced outside from the chamber frame to the door-side introduction block. When the door is closed, the gas flow path of the door-side introduction block and the gas flow path of the chamber-side introduction block communicate with each other.

### BACKGROUND OF THE INVENTION

1. Field of the Invention

The present invention relates to a gas supply device capable of connecting a gas pipe in accordance with opening/closing of a door in gas supply of a vacuum apparatus and a vacuum processing apparatus having the gas supply device.

2. Description of the Related Art

For example, in a sputtering apparatus disclosed in Japanese Patent Laid-Open No. 2002-68476, a cathode is attached to a door which is opened and closed with respect to a vacuum vessel via a hinge. A gas pipe is laid using a flexible tube, and discharge gas is supplied outside from the door to the cathode via the gas pipe.

When a plurality of cathodes are attached to one door, the difference in length between pipes for supplying gas to the respective cathodes results in the difference in timing to supply gas to the respective cathodes. To prevent this, pipes need to be laid to have the same pipe route length.

However, laying a flexible tube outside the vacuum vessel requires a long pipe route, impairing gas supply response and maintenance.

A long pipe route requires many pipe members, which is disadvantageous to cost reduction. Further, the flexible tube may contact and damage another member of the vacuum apparatus upon the opening/closing operation of the door.

### SUMMARY OF THE INVENTION

The present invention has been made to solve the above problems, and has as its object to provide a gas supply device capable of shortening a gas pipe route laid outside a vacuum vessel so that timings to supply discharge gas to respective cathodes coincide with each other, and achieving quick gas response, easy maintenance, high reliability, and cost reduction, and a vacuum processing apparatus having the gas supply device.

According to one aspect of the present invention, there is provided a gas supply device comprising: a chamber frame;
a door which is attached to the chamber frame to be able to open and close the door, and has a cathode;
a door-side introduction block which is attached to the door and has a gas flow path for supplying discharge gas to the cathode; and
a chamber-side introduction block which is attached to the chamber frame and has a gas flow path for supplying discharge gas introduced outside from the chamber frame to the door-side introduction block,
wherein when the door is closed, the gas flow path of the door-side introduction block and the gas flow path of the chamber-side introduction block communicate with each other.

According to another aspect of the present invention, there is provided a vacuum processing apparatus comprising the above-mentioned gas supply device.

Using a gas pipe device of the present invention as a means for supplying gas to a vacuum vessel can shorten a gas pipe route laid outside the vacuum vessel, improving gas response, maintenance, and reliability. Further, the number of components used for gas supply can be decreased, reducing the cost.

Further features of the present invention will become apparent from the following description of exemplary embodiments (with reference to the attached drawings).

### BRIEF DESCRIPTION OF THE DRAWINGS

FIG. 1 is a view of the schematic arrangement of an inline deposition apparatus according to an embodiment of the present invention;

FIG. 2 is a schematic sectional view of a deposition chamber taken along the line I-I according to the embodiment of the present invention;

FIG. 3 is a schematic sectional view of the deposition chamber taken along the line II-II according to the embodiment of the present invention;

FIG. 4 is a view of a gas system according to the embodiment of the present invention;

FIG. 5 is an enlarged sectional view of portion A in FIG. 2;

FIG. 6 is a perspective view of a chamber-side introduction block and door-side introduction block according to the embodiment of the present invention; and

FIG. 7 is a side view of the door-side introduction block according to the embodiment of the present invention.

### DESCRIPTION OF THE EMBODIMENTS

A preferred embodiment of the present invention will now be described with reference to the accompanying drawings. It should be noted that members, arrangements, and the like set forth in the embodiment are merely examples of the present invention, do not limit the scope of the present invention, and can be variously modified without departing from the scope of the invention.

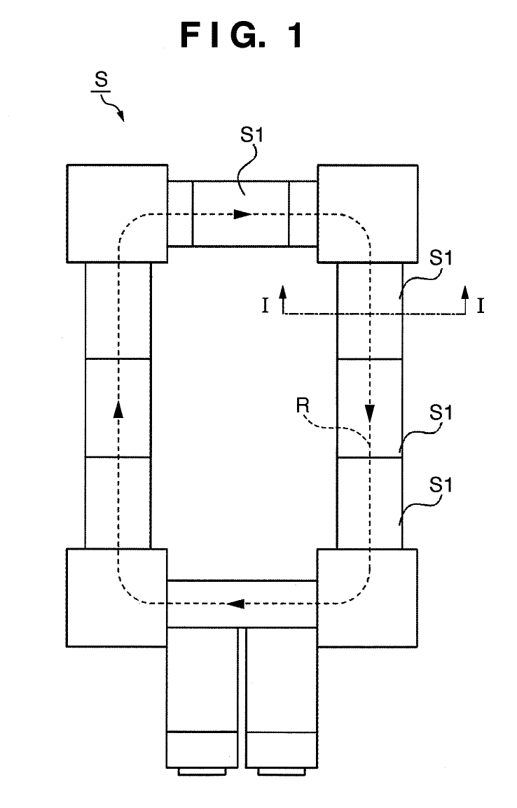

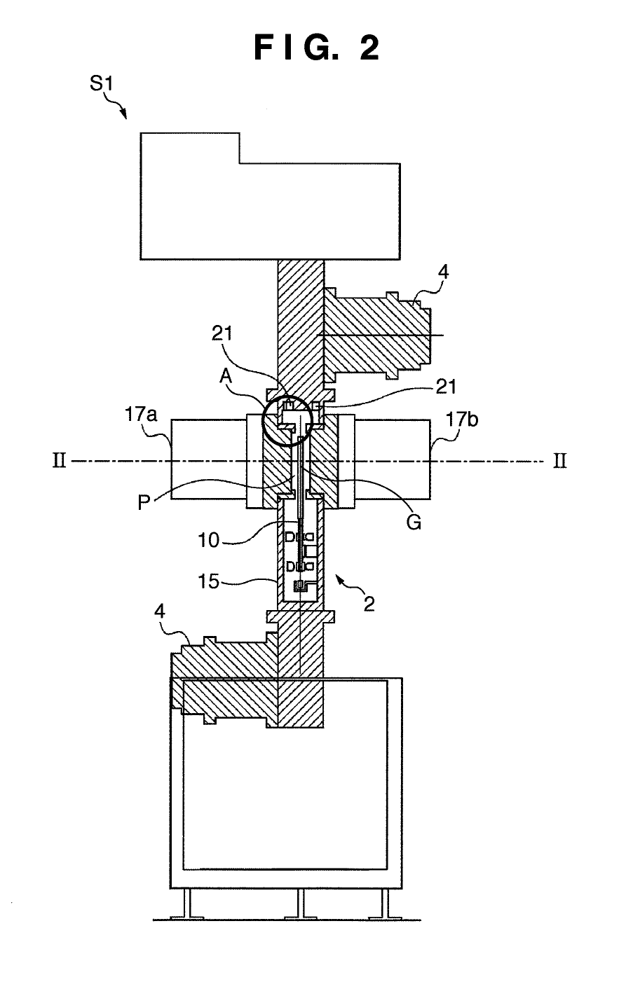

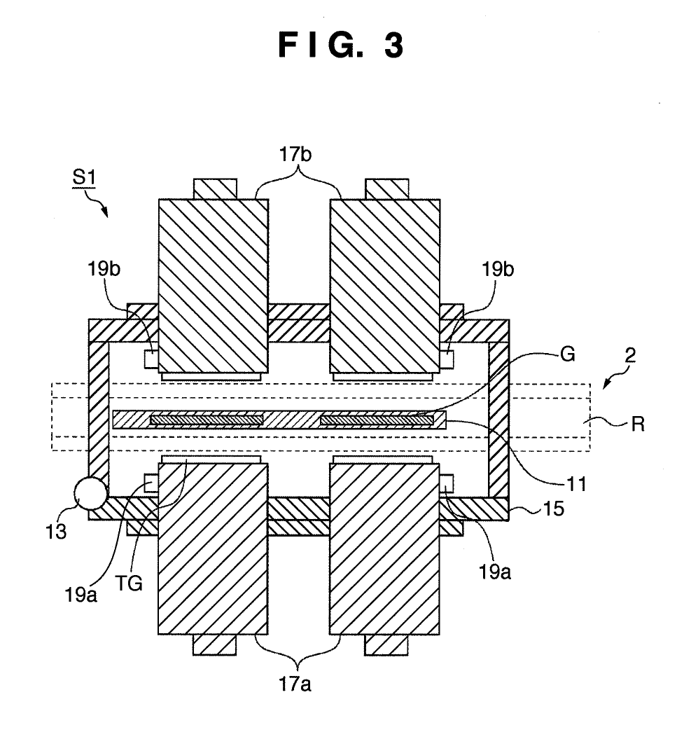

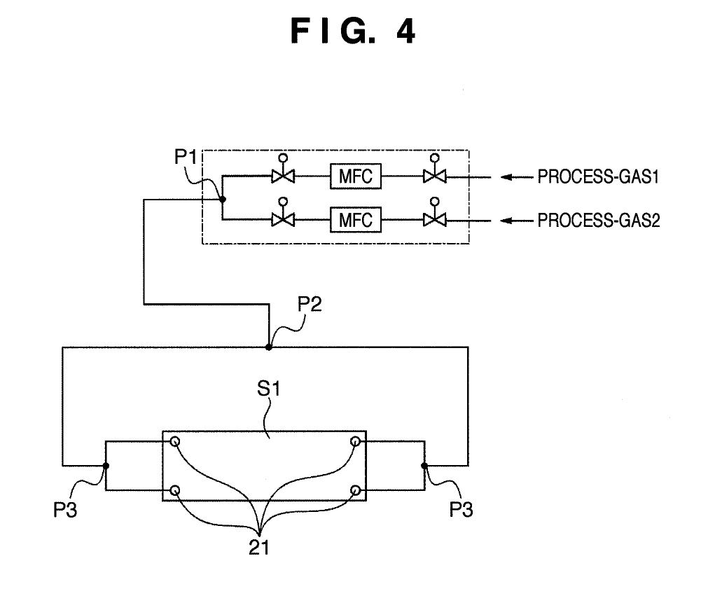

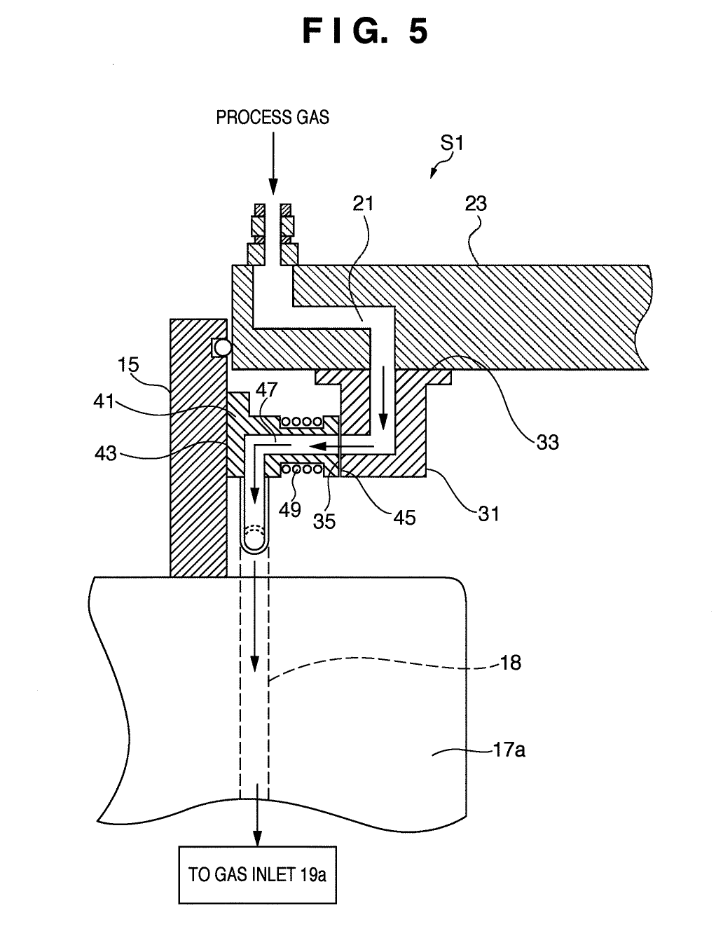

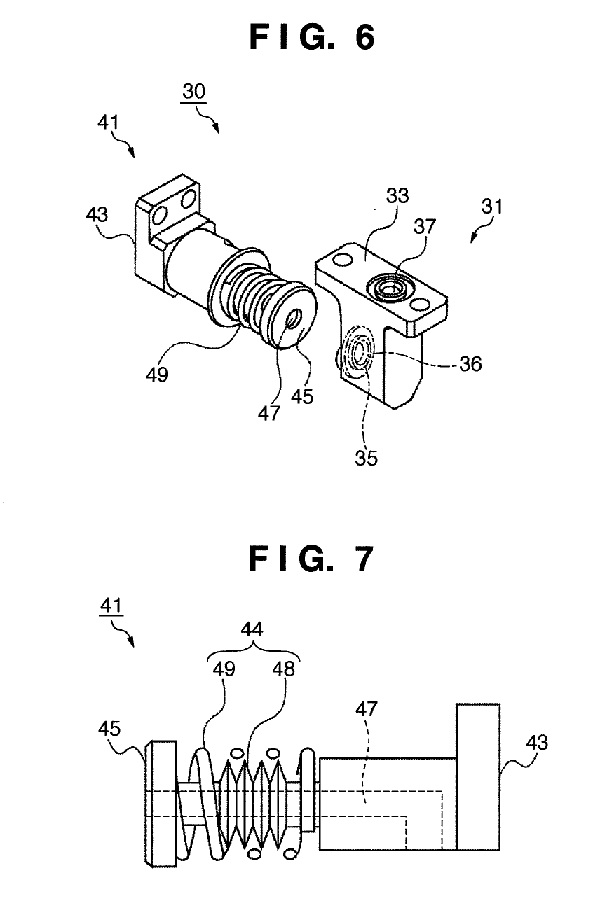

FIGS. 1 to 7 show an embodiment of the present invention. FIG. 1 is a view of the schematic arrangement of an inline deposition apparatus. FIG. 2 is a schematic sectional view of a deposition chamber taken along the line I-I. FIG. 3 is a schematic sectional view of the deposition chamber taken along the line II-II. FIG. 4 is a view of a gas system. FIG. 5 is an enlarged sectional view of portion A in FIG. 2. FIG. 6 is an enlarged view of a gas pipe connecting portion. FIG. 7 is a side view of a seal member.

An inline deposition apparatus S shown in FIG. 1 includes a plurality of vacuum chambers functioning as deposition chambers S1 and other processing chambers. These vacuum chambers are coupled into a rectangular shape. A substrate G is transported along a substrate transport route R of the inline deposition apparatus S and undergoes predetermined processes in the respective processing chambers. In the embodiment, the substrate G is a disk-like member for a storage medium such as a magnetic disk or optical disk. By replacing a substrate holder 11 (to be described later), the present invention is applicable to glass substrates, silicon substrates, resin substrates, and the like with a variety of shapes.

In this specification, a gas supply device 1 for a cathode arranged in the deposition chamber S1 serving as a sputtering apparatus which is a vacuum processing apparatus will be exemplified, but the present invention is not limited to this. For example, the present invention is preferably applicable to even a reactive gas supply device used in a reactive PVD apparatus or a source gas supply device used in a CVD apparatus, or a gas supply device for an ashing apparatus, dry etching apparatus, or the like.

The deposition chamber S1 shown in FIG. 2 is one processing chamber which builds the inline deposition apparatus S. The deposition chamber S1 can perform deposition processing for the substrate G by sputtering. The deposition chamber S1 incorporates a substrate transport device 2 which is connected to a vacuum pump 4 and can transport the substrate G. The substrate transport device 2 is a so-called vertical transport device, and can transfer the substrate G to each vacuum chamber while a carrier member 10 holds it in a vertical attitude. Two substrate holders 11 capable of holding a disk-like member are attached to the upper portion of the carrier member 10.

As shown in FIG. 3, a door 15 which can be opened and closed via a hinge 13 with respect to the deposition chamber S1 is attached to a wall surface on one side of the deposition chamber S1 (chamber). Note that the deposition chamber S1 (chamber) to which no door is attached will be called a chamber frame. The door 15 has cathode units 17, that is, 17a, 17b each capable of mounting a target TG serving as a vapor deposition source.

To perform deposition processing simultaneously on the two surfaces of the substrate G held by the substrate holder 11, a plurality of cathode units 17a and 17b are arranged on the two sides of the transport route R for the substrate G. As will be described later, the cathode units 17a are attached to the door 15, and the cathode units 17b are attached to the wall surface of the deposition chamber S1.

When the door 15 of the deposition chamber S1 is closed, the cathode units 17a attached to the door 15 face, at a predetermined distance, the substrates G supported by the substrate holders 11. Needless to say, the interior of the deposition chamber S1 is kept airtight while the door 15 is closed.

The door 15 and cathode units 17a will be explained in more detail. As described above, the door 15 is attached to the chamber frame via the hinge 13 to be able to open and close the door 15. Two cathode units 17a are arranged side by side near the center of the door 15. The cathode units 17a and 17b are connected to a gas supply device having gas pipes for supplying discharge gas such as argon gas used for sputtering, in addition to a power cable and cooling water supply pipe.

The route of discharge gas guided by the gas pipe will be described. Argon gas is supplied to the four cathode units 17, that is, two cathode units 17a and two cathode units 17b via gas pipes from an argon supply source arranged above the deposition chamber S1. Argon gas to be supplied to the cathode unit 17b is introduced from the argon supply source into the deposition chamber S1 via a pipe formed from a stainless steel flexible tube after passing through a mass flow controller (MFC) and a gas communication path 21. In the deposition chamber S1, a copper or stainless steel pipe guides the argon gas to a gas inlet 19b of the cathode unit 17b.

Next, the route of gas supply to the cathode unit 17a attached to the door 15 will be explained. The route to the cathode unit 17a is the same as that to the cathode unit 17b until argon gas supplied from the argon supply source is introduced into the deposition chamber S1 via a pipe formed from a stainless steel flexible tube after passing through the mass flow controller (MFC) and gas communication path 21. On the route to the cathode unit 17a, the argon gas is guided to a gas inlet 19a of the cathode units 17a, 17b through a connection block 30 (chamber-side introduction block 31 and door-side introduction block 41) arranged on the outlet side of the gas communication path 21 and a gas pipe 18 made of copper or stainless steel. In this specification, the gas supply device 1 is an arrangement including the gas pipe 18 and connection block 30 for guiding discharge gas. Argon gas will be exemplified as discharge gas, but oxygen gas-containing argon gas or another discharge gas is also available.

A gas supply route on the air side of the deposition chamber S1 will be described with reference to FIG. 4. A gas supply route inside the deposition chamber S1 will be explained with reference to FIGS. 5 to 7.

In the embodiment, as shown in the gas system view of FIG. 4, argon gas flows supplied from two argon supply sources are respectively adjusted by MFCs and then merged (position P1). A gas pipe after the gas pipes are merged downstream of the MFCs is branched again (positions P2 and P3) in accordance with the number of cathode units 17a and 17b. On the downstream side, the branched gas pipes are guided to the gas communication paths 21 formed in the chamber wall of the deposition chamber S1 (top plate of the deposition chamber S1). A pressure gauge is attached to a gas pipe between the position (position P1) where the gas pipes are merged after adjustment by the MFCs, and the position (position P2) where the gas pipe is branched.

In the embodiment, as shown in the gas system view of FIG. 4, four gas communication paths 21 are formed in the top plate of the deposition chamber S1. This is because the deposition chamber S1 has a total of four cathode units 17, that is, two cathode units 17a and two cathode units 17b. Pipes which form gas flow paths from the branch position (position P2) on the downstream side of the MFCs to the respective gas communication paths 21 are adjusted to have the same length. By setting the gas flow paths to have the same length, the differences in gas supply timing and gas response between the gas flow paths can be canceled. As a matter of course, gas flow paths from the respective gas communication paths 21 to the gas inlets 19a and 19b of the cathode units 17a and 17b have the same length.

Note that the MFC is a known device which adjusts the flow rate of argon gas supplied from an argon supply source such as an argon gas cylinder to a preset value and then supplies the argon gas to a cathode. Valves are attached before and after the MFC.

As shown in FIG. 5, the gas communication path 21 is a gas flow path which extends through the chamber wall of the deposition chamber S1. The gas communication path 21 is formed to extend through an upper wall 23 of the deposition chamber S1. Argon gas supplied from the MFC side passes through the gas communication path 21 and is guided into the deposition chamber S1.

Note that the gas communication path 21 in the embodiment is formed as a passage which is bent in the upper wall 23, but may be a straight passage.

Argon gas which has been guided into the deposition chamber S1 via the gas communication path 21 on the side of the door 15 is guided to the connection block 30. The connection block 30 is formed from a pair of the chamber-side introduction block 31 and door-side introduction block 41. When the door 15 is closed, the gas flow paths of the chamber-side introduction block 31 and door-side introduction block 41 are connected to supply argon gas to the cathode. Details of the connection block 30 will be described later.

The argon gas having passed through the connection block 30 is guided to the gas pipe 18, and then introduced into the cathode unit 17 via the gas inlet 19a formed in the side wall of the cathode unit 17a. The argon gas introduced into the cathode unit 17a is sprayed toward the front surface of the target TG from a gas injection port (not shown) formed near the edge of the target TG attached to the cathode unit 17.

The connection block 30 will be explained with reference to FIGS. 6 and 7.

FIG. 6 is a perspective view of the chamber-side introduction block 31 and door-side introduction block 41. The chamber-side introduction block 31 includes a chamber-fixed portion 33 which is fixed to the top surface of the deposition chamber S1, a chamber-side seal surface 35 which abuts against the door-side introduction block 41, and a gas flow path 37 which is formed to enable gas circulation between the chamber-fixed portion 33 and the chamber-side seal surface 35. The gas flow path 37 of the chamber-fixed portion 33 is connected to the gas communication path 21. An O-ring 36 is attached to the chamber-side seal surface 35 so as to hold sealing between the chamber-side introduction block 31 and the door-side introduction block 41.

As shown in FIG. 7, the door-side introduction block 41 includes a door-fixed portion 43 which is fixed to the inner surface of the door 15, an expandable portion 44 which is coupled to the door-fixed portion 43, a door-side seal surface 45 which is formed at the end of the expandable portion 44 and abuts against the chamber-side seal surface 35 of the chamber-side introduction block 31, and a gas flow path 47 which is formed to enable gas circulation between the door-fixed portion 43 and the door-side seal surface 45. The expandable portion 44 interposed between the door-fixed portion 43 and the door-side seal surface 45 is coupled to them by a flexible tube 48. A coil spring 49 is wound around the flexible tube 48. FIG. 7 shows the section of part of the coil spring 49.

While the flexible tube 48 is inserted in a space formed by the coil spring 49, the coil spring 49 is arranged with its upper and lower bearing surfaces in contact with the back surfaces of the door-fixed portion 43 and door-side seal surface 45. That is, the back surfaces of the door-fixed portion 43 and door-side seal surface 45 are always biased by the coil spring 49 in its expansion direction.

The operations of the chamber-side introduction block 31 and door-side introduction block 41 along with opening/closing of the door 15 will be explained. When the door 15 is open, the door-side seal surface 45 of the door-side introduction block 41 is spaced apart from the chamber-side seal surface 35 of the chamber-side introduction block 31. If argon gas is supplied in this state, it is released into air from the gas flow path 37 of the chamber-side seal surface 35.

When the door 15 is closed, the door-side seal surface 45 of the door-side introduction block 41 abuts against the chamber-side seal surface 35 of the chamber-side introduction block 31. The door-side seal surface 45 is biased toward the chamber-side seal surface 35 by the elastic force of the flexible tube 48 and coil spring 49. As a result, the chamber-side seal surface 35 always receives a pressing force from the door-side seal surface 45.

At this time, the gas flow path 37 of the chamber-side introduction block 31 and the gas flow path 47 of the door-side introduction block 41 communicate with each other. The door-side seal surface 45 and chamber-side seal surface 35 are pressed against each other via the O-ring 36, sealing the gas flow paths 37 and 47.

The door 15 is opened and closed via the hinge 13. When closing the door 15, the door-side seal surface 45 comes close to the chamber-side seal surface 35 at an angle. The angle in the direction of the pressing force changes until the door is closed after the door-side seal surface 45 and chamber-side seal surface 35 come into contact with each other. As described above, in the door-side introduction block 41, the door-fixed portion 43 and door-side seal surface 45 are coupled by the flexible tube 48, and the coil spring 49 is arranged to surround the outer surface of the flexible tube 48.

With this structure, the door-side seal surface 45 can be flexibly bent even diagonally while it is biased in the expansion direction. Even if the door-side seal surface 45 and chamber-side seal surface 35 contact each other at an angle, the door-side seal surface 45 can tightly contact the chamber-side seal surface 35, maintaining sealing between the seal surfaces 35 and 45.

The embodiment adopts the flexible tube 48 made of stainless steel, but may use another tube made of a resin or the like. When a highly elastic flexible tube is used, the coil spring 49 may be omitted. The expandable portion 44 may be arranged in the chamber-side introduction block 31.

The coil spring 49 is a compression coil spring having a straight shape, but may be a conical coil spring (conical spring) whose diameter gradually increases from the side of the door-side seal surface 45. The conical spring makes it difficult to buckle the spring. This is effective when a door opening/closing mechanism in which the expandable portion 44 is greatly bent is employed or the flexible tube needs to be formed longer.

The pressure gauge (not shown) is attached to the gas flow path on the cathode side of the MFC as a means for confirming that sealing between the door-side seal surface 45 and the chamber-side seal surface 35 is reliably achieved. This arrangement can detect a foreign matter sandwiched between the seal surfaces 35 and 45, or abnormal sealing arising from deterioration of the O-ring 36 or the like. If sealing is imperfect, abnormal sealing can be found out by reading a pressure gauge value in gas supply.

In the embodiment, the pressure gauge (not shown) is attached to a gas pipe between the position (position P1 in FIG. 4) where the gas flow paths are merged after adjustment by the MFCs, and the position (position P2 in FIG. 4) where the gas flow path is branched again. One pressure gauge can, therefore, detect even a case in which sealing of one of the four cathodes is imperfect. Also, another pressure gauge may be attached immediately before a position where the gas flow path is connected to each cathode unit 17.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-188820 filed Aug. 18, 2009, Japanese Patent Application No. 2010-175719 filed Aug. 4, 2010, which are hereby incorporated by reference herein in their entirety.

What is claimed is:

1. A gas supply device comprising:
a chamber frame;
a door which is attached to said chamber frame to be able to open and close said door, and has a cathode;
a door-side introduction block which is attached to said door and has a gas flow path for supplying discharge gas to the cathode; and
a chamber-side introduction block which is attached to said chamber frame and has a gas flow path for supplying discharge gas introduced outside from said chamber frame to said door-side introduction block,
wherein when said door is closed, the gas flow path of said door-side introduction block and the gas flow path of said chamber-side introduction block communicate with each other.

2. The gas supply device according to claim 1, wherein
said door-side introduction block comprises
a door-fixed portion which is fixed to said door,
a door-side seal portion which abuts against said chamber-side introduction block, and
an expandable portion which couples the door-fixed portion and the door-side seal portion, and
the expandable portion has a flexible tube.

3. The gas supply device according to claim 2, wherein
the expandable portion has the flexible tube and a coil spring, and
the flexible tube is inserted in a space formed by the coil spring.

4. A vacuum processing apparatus comprising a gas supply device defined in claim 1.
